(19) United States
(12) Patent Application Publication
(10) Pub. No.: US 2023/0321673 A1
(43) Pub. Date: Oct. 12, 2023

(54) PRESSURE WASHER RIFLE

(71) Applicant: THOMAS JASON BARLOW, BONITA SPRINGS, FL (US)

(72) Inventor: THOMAS JASON BARLOW, BONITA SPRINGS, FL (US)

(21) Appl. No.: 17/717,082

(22) Filed: Apr. 10, 2022

(51) Int. Cl. B05B 7/04; B05B 7/24; B05B 7/32

(52) U.S. Cl. CPC B05B 7/0408; B05B 7/244; B05B 7/32

(57) ABSTRACT

A pressure washer rifle can appear like a long arm firearm and can include a main body including a receiver having a magazine well, and a handguard and a grip connected to the receiver; a first conduit extending from the grip to the handguard; a second conduit extending from the magazine well to the handguard; a trigger valve; a trigger element; a hollow container containing a liquid detergent; and a venturi valve to fluidly engage the first and second outlet ends.

### FIELD OF THE INVENTION

The present invention relates to pressure washers.

### BACKGROUND OF THE INVENTION

Pressure washer systems generally include a compressor and pressure washer gun, which are used to direct pressurized water at objects to clean such objects.

### SUMMARY OF THE INVENTION

It is an object of the present invention to provide a pressure washer rifle.

It is another object of the present invention to provide a pressure washer rifle that provides functional utility, including one that can used as a pressure washer gun.

The present invention provides a pressure washer rifle that appears like a long arm firearm, and serves as a pressure washer gun.

In an exemplary embodiment of the present invention, a pressure washer rile can include a main body, first and second conduits, a trigger valve, a trigger element, a hollow container, and a venturi valve.

In an exemplary aspect of the present invention, such a main body can include a receiver having a trigger aperture and a magazine well, a handguard connected to the receiver, and a grip connected to the receiver.

In another exemplary aspect, such a first conduit can extend from the grip to the handguard and can have first inlet and outlet ends, with the first inlet end extending to the grip and being configured to couple to a pressurized water source, and the first outlet end extending to the handguard.

In a further exemplary aspect, such a second conduit can extend from the magazine well to the handguard and can have second inlet and outlet ends, with the second inlet end extending to the magazine cavity and the second outlet end extending to the handguard.

In still another exemplary aspect, such a trigger valve can be operatively coupled to the first conduit and can be configured to open and close the trigger valve.

In yet another exemplary aspect, such a trigger element can be operatively connected to the trigger valve and can extend though the trigger aperture.

In still yet another exemplary aspect, such a hollow container can be configured to contain a liquid detergent and to engage the magazine well so as to fluidly engage the second inlet end.

In another exemplary aspect, such a venturi valve can be configured to fluidly engage the first and second outlet ends and to provide a venturi effect on the second outlet end when a fluid flows from the first conduit inlet to the first conduit outlet.

In still another exemplary aspect, such a receiver can be provided as an upper receiver and a lower receiver connected together, with a handguard being connected to the upper receiver and the grip being connected to the lower receiver.

In a further exemplary aspect, such a main body can further include a buttstock connected to the receiver.

In another exemplary aspect, such a rifle can further include a detergent valve connected to the second conduit.

In yet additional exemplary aspects, such a venturi valve can be removably attached to the handguard and/or be configured to appear as a suppressor.

### BRIEF DESCRIPTION OF THE DRAWINGS

FIG. 1 illustrates an exemplary pressure washer rifle having a main body with a magazine well, handguard, and a grip; a trigger element; a container; and a venturi valve.

FIG. 2 illustrates an exemplary pressure washer rifle having first and second conduits.

FIG. 3A illustrates a top view of a container having an access aperture, a fill aperture, and a lid in a closed position.

FIG. 3B illustrates a top view of a container having an access aperture, a fill aperture, and a lid in an open position.

FIG. 4 illustrates an exemplary venturi valve engaged with a handguard in an operational state.

FIG. 5 illustrates a front view of an exemplary venturi valve engaged with a handguard in an exemplary storage state.

FIG. 6 illustrates an exemplary engagement of a venturi valve engaged with a handguard with first and second channels being fluidly engaged with first and second outlet ends.

### DETAILED DESCRIPTION

It should be noted that this disclosure includes a plurality of embodiments each having a plurality of elements and aspects, and such elements and aspects need not necessarily be interpreted as being conjunctively required by one or more embodiments of the present invention. In particular, all combinations of such elements and aspects can enable a separate embodiment of the present invention, which may be claimed with particularity in this or any future filed patent application. Moreover, such elements and aspects disclosed herein or apparent herefrom, whether expressly or implicitly, are to be construed strictly as illustrative and enabling, and not necessarily limiting. Therefore, it is expressly set forth that any elements and aspects, independently or in any combination of one of more thereof, are merely illustratively representative of one or more embodiments of the present invention and are not to be construed as necessary in a strict sense.

Further, to the extent the same element or aspect is defined differently anywhere within this disclosure, whether expressly or implicitly, the broader definition is to take absolute precedence, with the distinctions encompassed by the narrower definition to be strictly construed as optional.

Illustratively, perceived benefits of the present invention can include functional utility, whether expressly or implicitly stated herein, or apparent herefrom. However, it is expressly set forth that these benefits are not intended as exclusive. Therefore, any explicit, implicit, or apparent benefit from the disclosure herein is expressly deemed as applicable to the present invention.

According to the present invention, a pressure washer rifle can be formed from any one or more materials or combinations of materials, such as one or more of plastic, rubber, wood, metal, crystalline material, or any other man-made or naturally occurring material, for example and not in limitation, insofar as functionally consistent with the present invention. Further, such a device can be manufactured in any one or more functionally compatible manners, such as through molding, cutting, machining, etc.

In an exemplary embodiment of the present invention, a pressure washer rifle can include a main body, first and second conduits, a trigger valve, a trigger element, a hollow container configured to contain a liquid detergent, and a venturi valve.

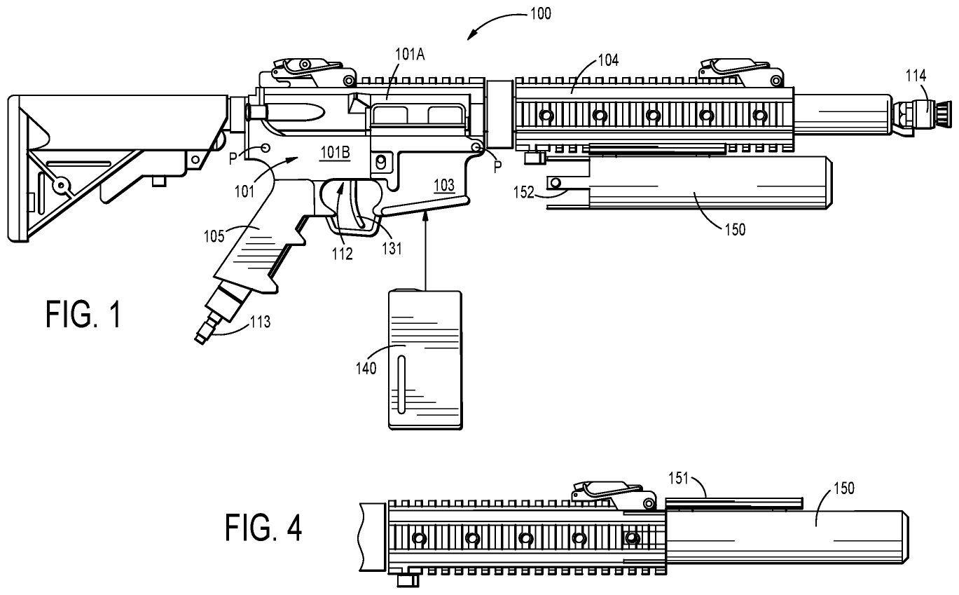

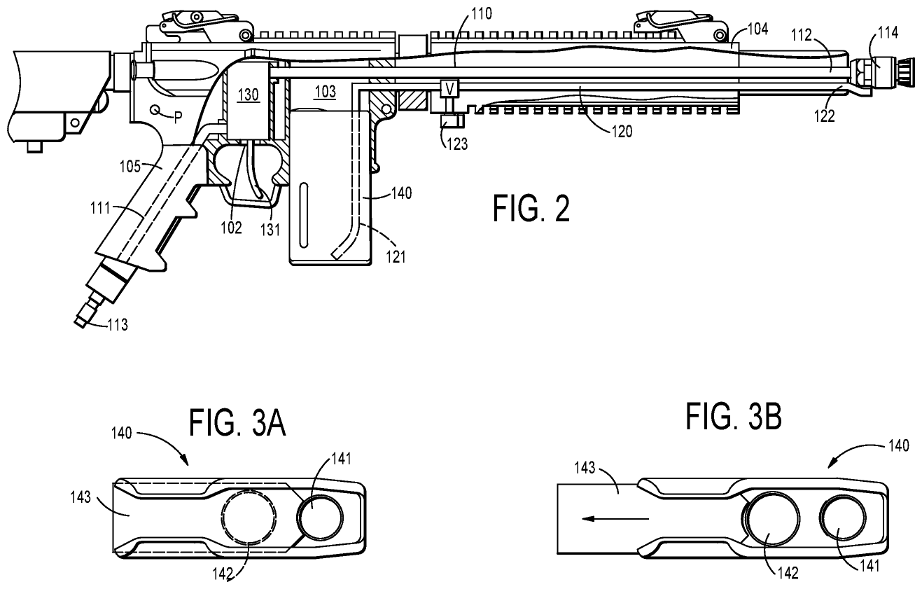

As illustrated in FIGS. 1 and 2, a main body 100 can include a receiver 101 having a trigger aperture 102 and a magazine well 103, a handguard 104 connected to the receiver, and a grip 105 connected to the receiver.

In an exemplary aspect, receiver 101 can be provided as a monolithic structure, or as illustrated in FIG. 1, a plurality of structures, such as an upper receiver 101A and a lower receiver 101B that can engage together, such as via pins P, for example and not in limitation, so as to more closely appear like a long arm firearm.

As illustrated in FIG. 2, a first conduit 110 can extend from grip 105 to handguard 104, and can include a first inlet end 111 extending to the grip and a first outlet end 112 extending to the handguard. In an exemplary aspect, first inlet end 111 can be configured to fluidly engage a pressurized water source (not shown), such as via a quick connect coupler 113, for example and not in limitation. In another exemplary aspect, first outlet end 112 can optionally include a nozzle assembly 114, which can provide a focused stream of liquid, which can further optionally, be adjustable.

As further illustrated in FIG. 2, a second conduit 120 can extend from magazine well 103 to handguard 104, and can include a second inlet end 121 extending to the magazine well and a second outlet end 122 extending to the handguard.

It should be noted that in describing the extent to which first and second inlet and outlet ends 111, 121, 112, 122 extend “from” or “to” magazine well 103, grip 105, and handguard 103, the instant invention contemplates such description to include before, exactly at, or beyond these structural reference points, insofar as functionally consistent with the instant invention.

FIG. 2 further illustrates an exemplary trigger valve 130 and trigger element 131. In an exemplary aspect, trigger valve 130 can be operatively connected to and positioned anywhere along first conduit 110, including at first inlet and outlet ends 111, 112 insofar as functionally consistent with the present invention. In another exemplary aspect, trigger element 131 can be moveably engaged with trigger valve 130, and can extend through trigger aperture 102 so as to be movable by a user to open and/or close the trigger valve.

FIG. 1 further illustrates an exemplary hollow container 140, which can be configured to contain a detergent. In an exemplary aspect, well 103 and container 140 can be complimentarily shaped to allow the container to be positioned within the well for engagement with the well and second inlet end 121. In another exemplary aspect, container 140 can be configured to appear like a firearm magazine.

FIGS. 3a and 3b illustrate top views of an exemplary container 140, which can include an access aperture 141 and a fill aperture 142. In additional exemplary aspects, access aperture 141 can be an open portion of a tube extending into container 140 or an opening into the container, for example and not in limitation. Further, container 140 can include an optional lid 143, which can cover (as illustrated in FIG. 3a) or expose fill aperture 142 via movement, such as sliding, for example and not in limitation. As illustratively shown in FIG. 2, second inlet end 121 can extend into container 140 through access aperture 141. Alternatively, second inlet end 121 can extend just to access aperture 141, such as where connecting to the opening of a bladder of detergent. Notably, container 140 can be provided with a single aperture, such as for both fluid communication and detergent filling.

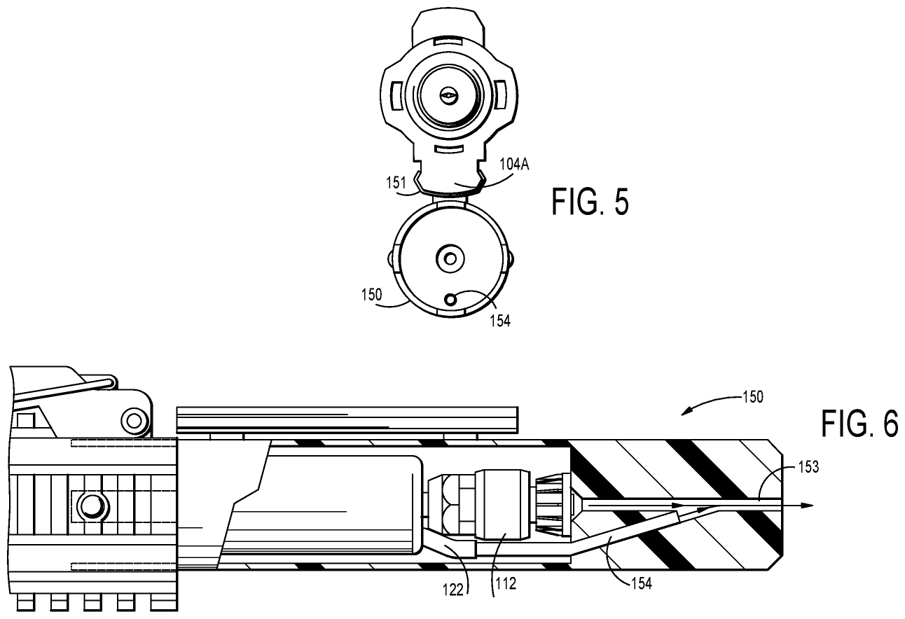

FIGS. 1, 4, and 5 illustrate an exemplary venturi valve 150, which can optionally be configured to appear like a firearm suppressor. In an exemplary aspect, venturi valve 150 can include a rail adapter 151, which can be configured to attach the venturi valve to handguard 104 for storage, such as by slidably engaging a picatinny rail 104a as illustrated in FIGS. 1 and 5, for example and not in limitation (c.f., magnetic and frictional attachment).

In another exemplary aspect, venturi valve 150 can include one or more attachment structures, such as one or more flanges 152 (see FIG. 1), for example and not in limitation, which can attach the venturi valve to handguard 104, such as by engaging under one or more provided picatinny rails 104a of the handguard (see FIG. 5), for example and not in limitation. However, engagement of venturi valve 150 to handguard 104 (or any intermediate structure) can be effectuated via any desired attachment structure(s), insofar as functionally consistent with the present invention (e.g., thread, pin, abutment, guide, clamp, etc.)

In still another exemplary aspect, as illustrated in FIG. 6, venturi valve 150 can include first and second channels 153, 154, with the first channel being configured to fluidly engage first outlet end 112 (such as via relative positional engagement, for example and not in limitation) and the second channel being configured to fluidly engage second outlet end 122 (such as one of the second channel and the second outlet end being positioned within the other, for example and not in limitation), when the venturi valve is engaged with handguard 104. Notably, first and second channels 153, 154 can respectively engage first and second outlet ends 112, 122 in any alternative manner and/or with any structure(s) desired, insofar as functionally consistent with the present invention. Moreover, such fluid engagement can be facilitated via one or more o-rings, for example and not in limitation. It should be further noted that venturi valve 150 can be engaged with first and second outlet ends 112, 122 anywhere along first and second conduits 110, 120 insofar as functionally consistent with the present invention.

As further illustrated in FIG. 6, first and second channels 153, 154 can be configured to merge so as to cause a low pressure effect where the first and second channel merge, which can draw detergent from container 140 into the first channel.

In yet another exemplary aspect, as illustrated in FIGS. 1 and 2, second conduit 120 can include a detergent valve 123, which can be operatively connected to and positioned anywhere along the second conduit, including at second inlet and outlet ends 121, 122 insofar as functionally consistent with the present invention. In another exemplary aspect, detergent valve 123 can operate statically or variably.

It will be apparent to one of ordinary skill in the art that the manner of making and using the claimed invention has been adequately disclosed in the above-written and attached description of the exemplary embodiments and aspects of the present invention.

It should be understood, however, that the invention is not necessarily limited to the specific embodiments, aspects, arrangement, and components shown and described above, but may be susceptible to numerous variations within the scope of the invention. For example, while a venturi valve was illustratively shown as a means for moving a liquid, a mechanical or electric motor could be substituted as an equivalent. Therefore, the specification and drawings are to be regarded in an illustrative and enabling, rather than a restrictive, sense.

Accordingly, it will be understood that the above description of the embodiments of the present invention are susceptible to various modifications, changes, and adaptations, and the same are intended to be comprehended within the meaning and range of equivalents apparent to one of ordinary skill in the art.

Therefore, I claim:

1. A pressure washer rifle that appears like a long arm firearm, comprising:
a main body including a receiver having a trigger aperture and a magazine well, a handguard connected to the receiver, and a grip connected to the receiver;
a first conduit extending from the grip to the handguard, said first conduit having a first inlet end extending to the grip and being configured to couple to a pressurized water source, and a first outlet end extending to the handguard;
a second conduit extending from the magazine well to the handguard, said second conduit having a second inlet end extending to the magazine well, and a second outlet end extending to the handguard;
a trigger valve operatively coupled to said first conduit;
a trigger element operatively connected to the trigger valve and extending though the trigger aperture;
a hollow container configured to contain a liquid detergent and to engage the magazine well to fluidly engage the second inlet end; and
a venturi valve configured to fluidly engage the first and second outlet ends and to provide a venturi effect on said second conduit when a fluid flows from the first conduit inlet end to, and out of, the first conduit outlet end;
wherein the trigger structure is configured to at least one of open and close the trigger valve.

2. The rifle of claim 1, wherein said receiver includes an upper receiver and a lower receiver, with the handguard being connected to the upper receiver and the grip being connected to the lower receiver.

3. The rifle of claim 1, further comprising a detergent valve connected to the second conduit.

4. The rifle of claim 1, wherein said venturi valve is removably attached to the handguard.

5. The rifle of claim 1, wherein the venturi valve is configured to appear as a suppressor.

6. The rifle of claim 1, wherein the venturi valve includes a rail adapter configured to engage the handguard.
